(19) United States
(12) Patent Application Publication
(10) Pub. No.: US 2009/0229430 A1
(43) Pub. Date: Sep. 17, 2009

(54) Handle For Kitchen Tools

(75) Inventors: Jeffrey Siegel, Kings Point, NY (US); Hsin-Jung Lin, Forest Hills, NY (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: Lifetime Brands, Inc., Garden City, NY (US)

(21) Appl. No.: 12/247,024

(22) Filed: Oct. 7, 2008

Related U.S. Application Data
(63) Continuation-in-part of application No. 29/305,045, filed on Mar. 12, 2008, now Pat. No. D577956.

(51) Int. Cl. B25B 23/16

(52) U.S. Cl. 81/489

(57) ABSTRACT

A handle for kitchen tools made of an injection molded rigid material over molded with a soft outer layer. The handle includes an elongated body member, an inlay member, an insertion member, and a bolster. Each of the parts is connected to the elongated body member to form the assembled handle. The inlay member is attached to an upper face of the elongated body member. The insertion member is engagingly received within a receiving end of the elongated body member. The bolster covers the insertion member and receiving end of the elongated body member.

### CROSS-REFERENCE TO RELATED APPLICATION

This application is a continuation-in-part of U.S. patent application Ser. No. 29/305,045 filed 12 Mar. 2008. The above-listed application is herein incorporated by reference as if fully set forth below in its entirety.

### FIELD OF THE INVENTION

The present invention relates to handles for kitchen tools.

### BACKGROUND OF THE INVENTION

Most kitchen tools are rigid so they can effectively work yet inexpensive so that the consumer can buy multiple tools such as spoons, forks, spatulas, turners, presses, peelers, and whisks. The customer's need for relative rigidity and inexpensive materials have led to several problems, including: 1) the kitchen tools are often not very decorative because they are either a one piece tool or a tool that has a handle permanently attached to a tool head; 2) the kitchen tools are made of hard materials such as wood, metal, or plastic that are painful to use over a long period of time in the kitchen; 3) softer materials, which will be more comfortable than rigid ones, often have low heat tolerance and too much flexibility, which keeps the tool from functioning effectively; and 4) kitchen tools are often not very decorative because the cost needs to be low enough so that the general public can afford to own different tools.

What is needed therefore is a high quality handle design that can be used with multiple tool heads. It is to such a handle that the present invention is primarily directed.

### SUMMARY OF THE INVENTION

Briefly described, in preferred form, the present invention is a handle for kitchen tools made of an injection molded rigid material over molded with a soft outer layer. The handle can have decorative inlay members that are chrome-plated, and the handle can have a customizable insertion member and bolster so the same handle design can be used with various tool heads. The high quality handle is both rigid and soft on the outside so that a user's hand will not hurt from extended use. The handle also is durable and decorative.

The present invention can comprise a handle for a kitchen tool including an elongated body member having an upper and lower face, lateral walls, a receiving end, a hanging end, an inlay member receiving assembly, an insertion member receiving assembly, and a bolster receiving assembly, an inlay member located on the upper face of the elongated body member by the inlay member receiving assembly, an insertion member fittable into the receiving end of the elongated body member by the insertion member receiving assembly, and a bolster fittable over the insertion member and the receiving end of the elongated body member by the bolster receiving assembly.

The handle can comprise polypropylene overmolded with a soft wrapping of santoprene on the lower face and lateral walls. The inlay member receiving assembly can comprise one or more apertures sized and spaced to interact with one or more cooperative extensions of the inlay member, wherein the inlay member is press fittable to the elongated body member. The insertion member receiving assembly can comprise one or more ribs extending within a hollow space from an interior lateral wall of the receiving end of the elongated body member to interact with one or more cooperative extensions of the insertion member when the insertion member is inserted into the receiving end of the elongated body member. The bolster receiving assembly can comprise one or more depressions inside the bolster member to interact with one or more cooperative extensions of the elongated body member when the bolster member is placed over the receiving end of the elongated body member.

The handle can further comprise injection molded acrylonitrile butadiene styrene plated with chrome on the upper face of the elongated body member. The insertion member can comprise a tool aperture. The bolster too can comprise a tool aperture.

The present invention can further comprise a method of making a handle for use with a kitchen tool comprising molding an elongated body member with polypropylene, overmolding at least a portion of the elongated body member with santoprene, molding an inlay member with acrylonitrile butadiene styrene, chrome plating at least a portion of the inlay member, molding an insertion member with acrylonitrile butadiene styrene, molding a bolster with acrylonitrile butadiene styrene, chrome plating at least a portion of the bolster, and assembling the handle from the components molded as described above.

The present invention can further comprise a handle system for kitchen tools comprising an elongated body member with a first aperture on a hanging end going all the way through the end, a second smaller aperture in the middle of an upper face that does not extend to the lower face and a third smaller aperture on the upper face near a receiving end that does not extend to the lower face, overmolded with a soft outer layer on at least a portion of the lower face and lateral walls and leaving a space on the upper face for an inlay member, the inlay member having a first aperture on a hanging end with a coupling link protruding from the bottom of the aperture, and two pins protruding from its lower face, the coupling link fittable into the first aperture of the elongated body member, the inlay member being fittable on the upper face of the elongated body member between the soft outer layer on the lateral walls, the receiving end of the elongated body member having an opening and hollow area into which an insertion member is placed, the insertion member having lateral grooves and held inside the elongated body member by ribs on the interior lateral walls of the elongated body member, the insertion member having a tool aperture, a bolster attached on the other end of the extension member also with a tool aperture that extends from end to end, and a tool head placed in the tool aperture extending from the bolster into the insertion member.

These and other objects, features and advantages of the present invention will become more apparent upon reading the following specification in conjunction with the accompanying drawing figures.

### BRIEF DESCRIPTION OF THE DRAWINGS

FIG. 1 is an isometric view of a kitchen tool according to a preferred embodiment of the present invention.

FIG. 2 is an exploded view of the parts of the handle according to a preferred embodiment of the present invention.

FIG. 3a is a bottom view of the inlay member and the elongated body member according to a preferred embodiment of the present invention.

FIG. 3b is a top view of the inlay member and the elongated body member of FIG. 3a.

FIG. 4 is a perspective view of the assembled elongated body member of FIG. 2.

FIG. 5 is a perspective view of the inlay member of FIG. 2.

FIG. 6 is a perspective view of the insert of FIG. 2.

FIG. 7 is a perspective view of the bolster of FIG. 2.

FIG. 8 is an internal view of the elongated body member of FIGS. 2 and 4.

FIG. 9 is an isometric view of another preferred embodiment of the handle of the present invention.

FIG. 10 is a front view of the embodiment of the handle of FIG. 9.

FIG. 11 is a right side view of the embodiment of the handle of FIG. 9.

FIG. 12 is a rear view of the embodiment of the handle of FIG. 9.

FIG. 13 is a top view of the embodiment of the handle of FIG. 9.

FIG. 14 is a bottom view of the embodiment of the handle of FIG. 9.

### DETAILED DESCRIPTION

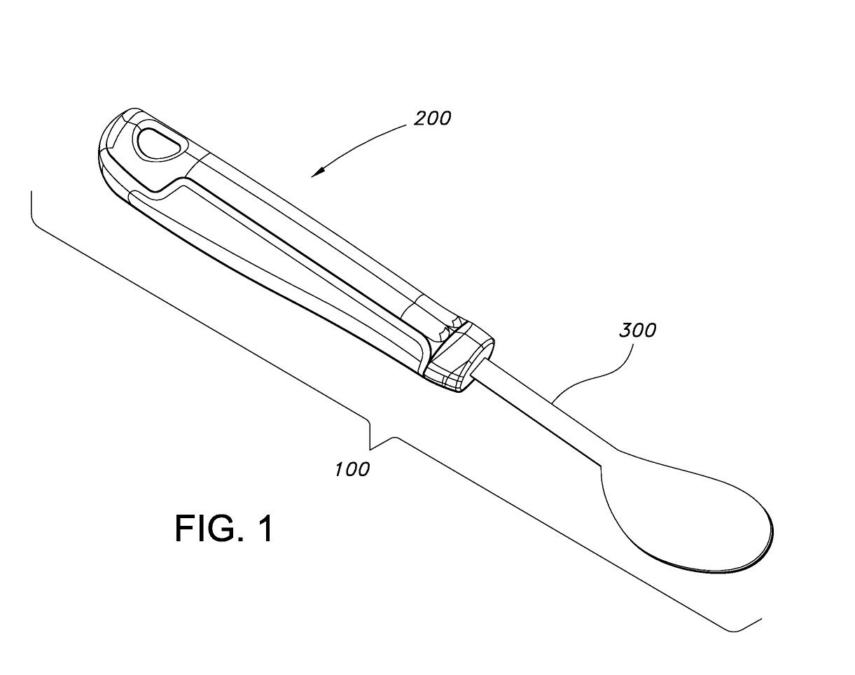

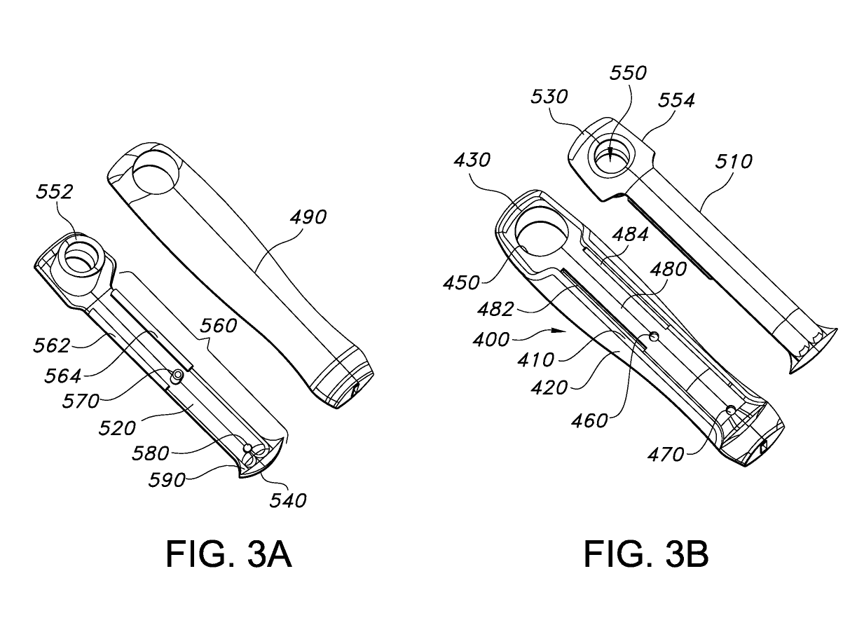

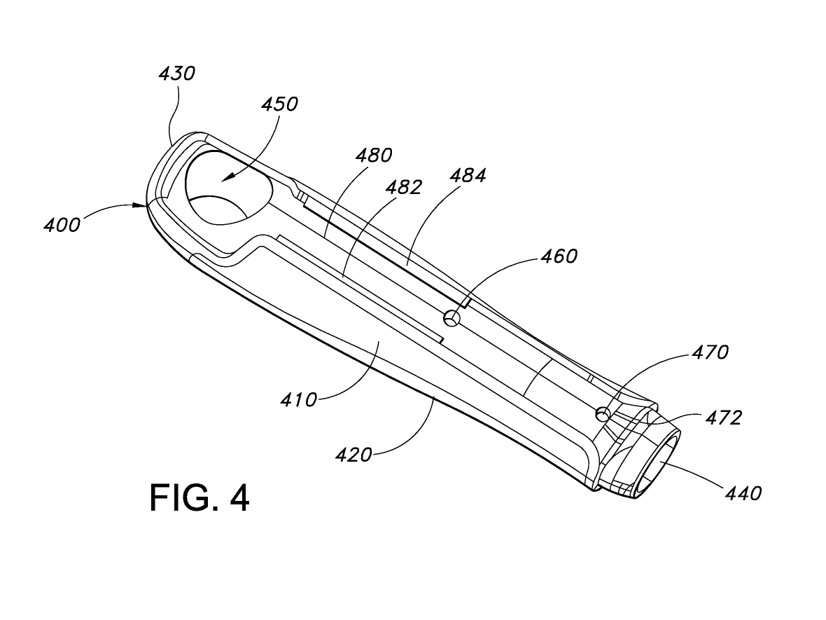

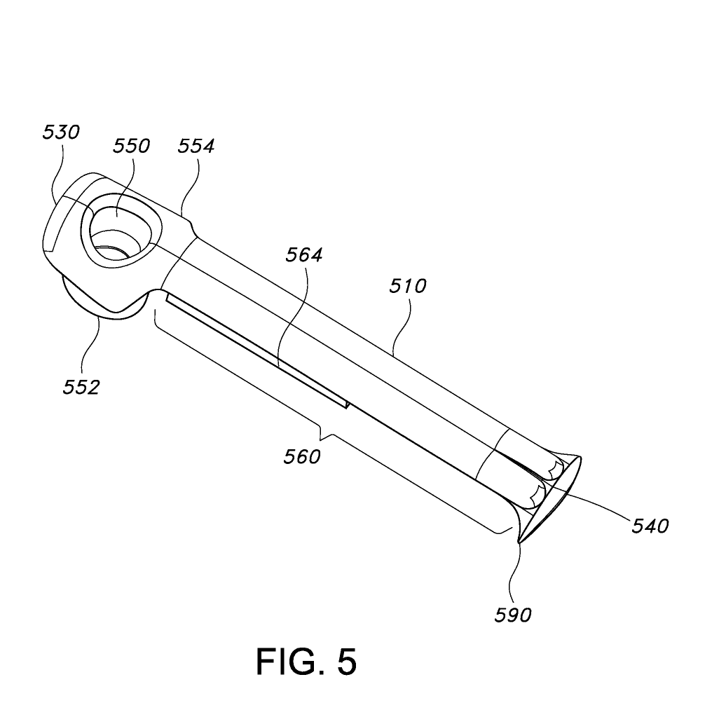

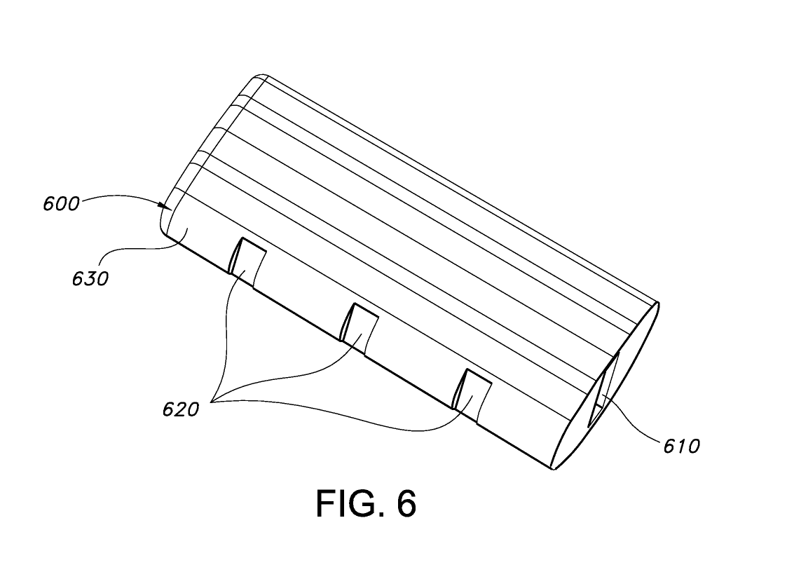

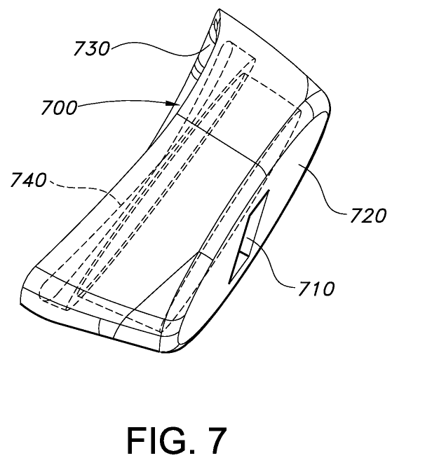

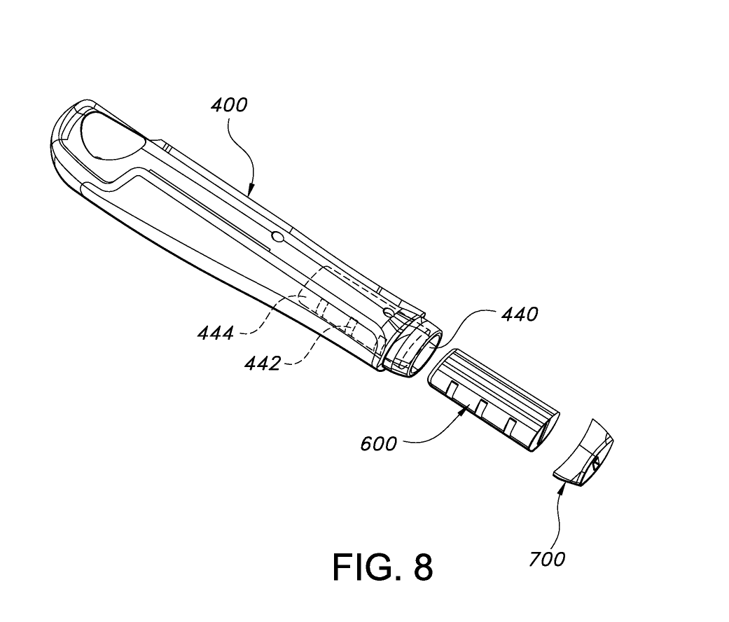

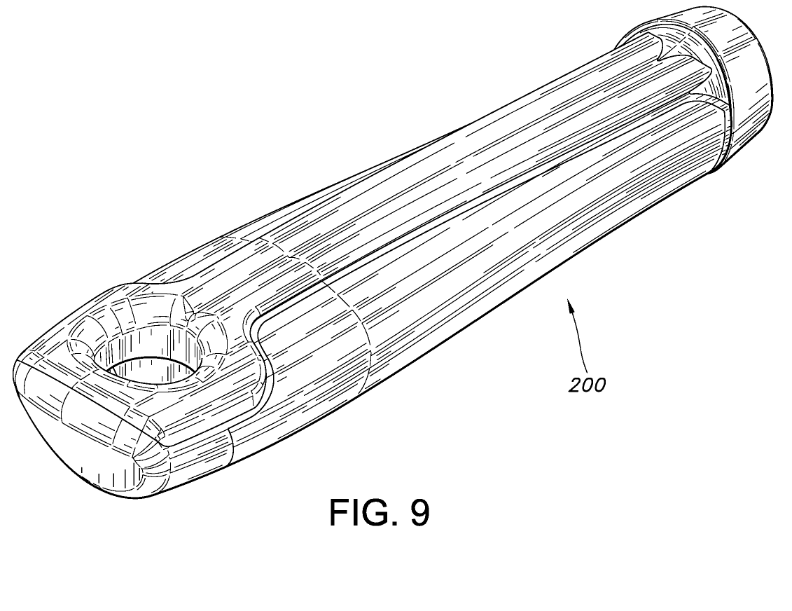

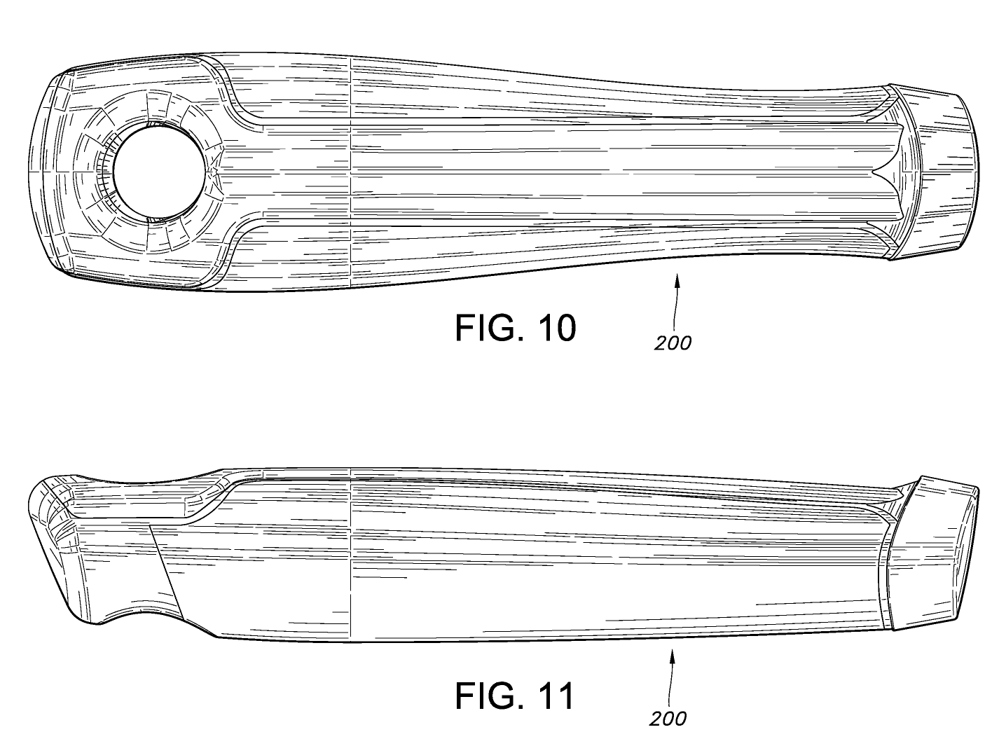

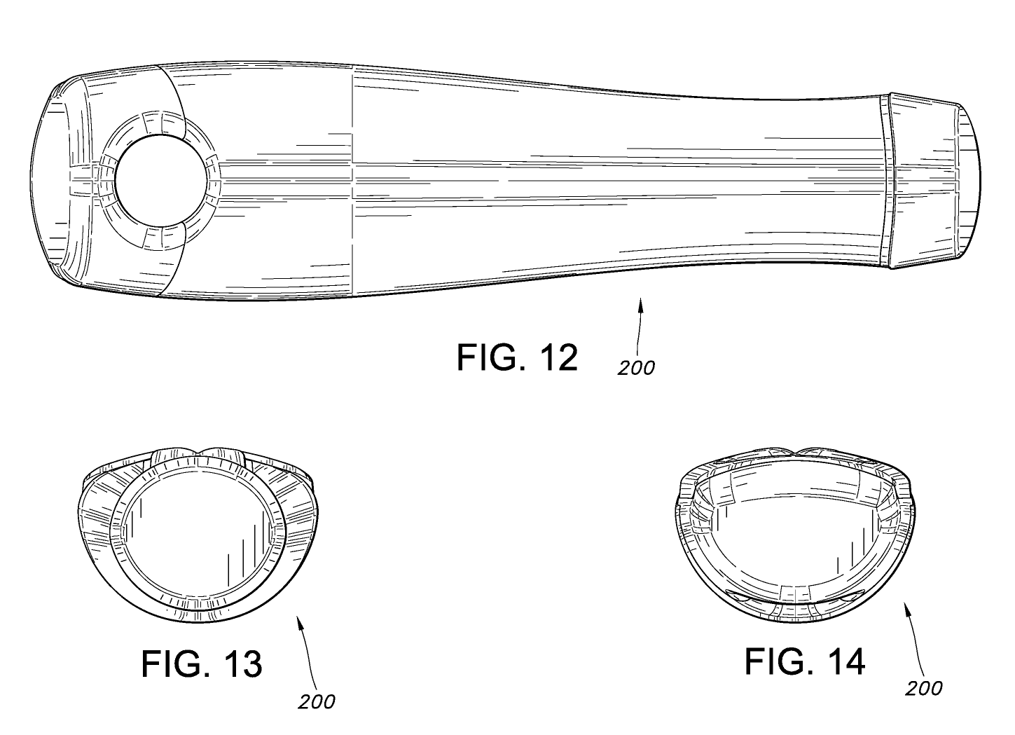

While the invention is susceptible to various modifications and alternative forms, a specific embodiment thereof has been shown by way of example in the drawings and will herein be described in detail. It should be understood, however, that there is no intent to limit the invention to the particular form disclosed, but on the contrary, the intention is to cover all modifications, equivalents, and alternatives falling within the spirit and scope of the invention as defined by the appended claims. Exemplary embodiments of the present invention are shown in FIGS. 1-14.

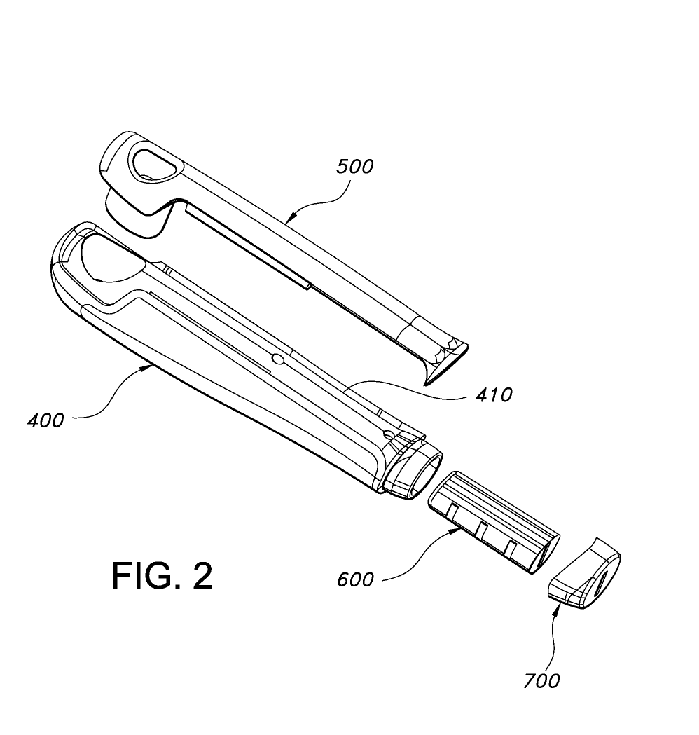

The kitchen utensil 100 in FIG. 1 has a tool head 300 attached to the handle 200. The handle 200 is comprised of an elongated body member 400, inlay member 500, insertion member 600, and a bolster 700 as best seen in FIG. 2. Each of the parts, inlay member 500, insertion member 600, and bolster 700, is connected to the elongated body member 400 via receiving assemblies to form the assembled handle 200.

The elongated body member 400 preferably comprises lateral walls 410, a hanging end 430, a receiving end 440, an upper face 480, a lower face 490, and incorporates an inlay member receiving assembly, an insertion member receiving assembly, and a bolster receiving assembly;

The inlay member 500 is attached to the upper face 480 of the elongated body member 400. The insertion member 600 is engagingly received within the receiving end 440 of the elongated body member 400. The bolster 700 covers the insertion member 600 and receiving end 440 of the elongated body member 400.

In a preferred embodiment, the handle 200 is permanently affixed to a single tool head 300, although in another embodiment, a handle 200 can be used with many different tool heads 300 to provide a less expensive and space-saving alternative to buying many kitchen tools. The handle 200 can be decorative yet at the same time have important ergonomic features such as being rigid enough to function, and yet being soft on the hand so that the hand will not hurt or blister from extended use.

The elongated body member 400 can be made of several materials. The elongated body member 400 can be made of an injection molded hard plastic, such as polypropylene, and overmolded with soft wrapping 420 of a softer plastic, such as thermoplastic elastomer material like SANTOPRENE™. An overmolding process firmly attaches a soft wrapping 420 on a lower face 490 and outer lateral walls 410 of the elongated body member 400.

The elongated body member 400 can include a number of apertures forming elements of the various receiving assemblies. In one embodiment, the member 400 is provided with a first set of circular apertures 450, 460, 470, and a second set of rectangular apertures 482, 484, although the number and shape can vary. The apertures of the member 400 cooperate with extensions of the inlay member 500 for proper alignment and engagement of the inlay member 500 to the member 400.

On its upper face 480, the elongated body member 400 has the first set of three apertures 450, 460, 470 and the second set of two apertures 482, 484 in the upper face between the lateral ends of the soft wrapping. A first aperture 450 of the first set of apertures is a through hole in the member 400, and is a relatively large aperture. A second and third aperture 460, 470 of the first set of apertures are not through holes, and are relatively small apertures, for example, pin sized apertures. In this embodiment, the second aperture 460 is located in the middle of the upper face 480, and the third aperture 470 is nearer the receiving end 440 of the member 400.

The two apertures 482 and 484 of the second set of apertures are generally long troughs indented into the hard plastic of the upper face. Each one of the apertures 482 and 484 is adjacent to the soft wrapping 420. The apertures 482 and 484 extend from just below the first aperture 450 to nearly in line with the second aperture 460.

The elongated body member 400 has a hanging end 430 and the receiving end 440. The hanging end 430 incorporates the first aperture 450 going through it, and can be used to hang the utensil 100 in the kitchen. The receiving end 440 presents a generally hollow space in the end of the elongated body member 400 for reception of the insertion member 600, and can incorporate ribs 442 or protrusions extending within the hollow space from an interior lateral wall 444, which ribs 442 will be useful for the engagement of the insertion member 600 into the receiving end 440 of the elongated body member 400.

The inlay member 500 can be made by injection molding acrylonitrile butadiene styrene, and then coating the acrylonitrile butadiene styrene with chrome on an upper face 510 thereof. The inlay member 500 can include a number of apertures and extensions that cooperate with the apertures of the member 400.

At a hanging end 530, the inlay member 500 can include an inlay member aperture 550 that cooperates with the first aperture 450 of the first set of apertures in the member 400. The inlay member aperture 550 is a through hole in the inlay member 500. Also at the hanging end 530, a flank 554 extends from the upper face 510 of the inlay member 500 on three sides of the aperture 550. An inlay member shaft 560 extends from the inlay member aperture 550. The length of the inlay member shaft 560 is several multiples of the width, which gives the inlay member shaft 560 a relatively long, thin appearance. The inlay member 500 has a receiving end 540, with points 590 that extend in a straight line horizontally with receiving end 540. The points 590 are connected to each lateral wall with an inverted arc.

On the lower face 520 of the inlay member 500, a coupling link 552 surrounds the inlay member aperture 550 and extends from the lower face 520 of the inlay member 500. The coupling link 552 is not as wide as the flank 554.

The inlay member 500 further comprises pins to cooperate with the some of the first set of apertures of member 400. For example, inlay member 500 can include two pins 570 and 580: a first pin 570 near the center both laterally and longitudinally of the lower face 520 of the inlay member 500; and a second pin 580 in the center laterally, but near the receiving end 540.

The inlay member 500 further comprises bars to cooperate with the second set of apertures of member 400. For example, inlay member 500 can includes two bars, a first bar 562 and a second bar 564, extending from the lower face 520 generally perpendicular to each lateral edge of the inlay member 500. Each distal end of the bars 562 and 564 can begin at the flank 554 surrounding the aperture, and extend near the second pin 580.

The insertion member 600 can be made of an injection molded hard plastic such as acrylonitrile butadiene styrene, and can be generally rectangular in shape. The insertion member 600 can have grooves, for example, three grooves 620 or cut-outs on its exterior lateral walls 630. Preferably, the lateral walls are longer than the ends. A tool aperture 610 is on a proximal receiving end of the insertion member 600. This tool aperture 610 does not go all the way through to the other end of the insertion member 600.

The bolster 700 is hollow on the distal end and is longer in width than in length. Inside the distal end is a depression 740 in the upper interior wall. From proximal end 720 to distal end 730, the bolster 700 has a tool aperture 710. The bolster 700 can be made of an injection molded hard plastic such as acrylonitrile butadiene styrene.

The handle 200 is preferably assembled by pressure fitting. In other words, the pieces are fit so snugly together that they resist being separated. The inlay member 500 is attached to the elongated body member in three ways:
the coupling link 552 in the inlay member 500 fits into the first aperture 450 of the elongated body 400;
the inlay member 500 is attached on the upper face 480 of the elongated body member 400 by pins 570 and 580 on the inlay member's lower face 520 that fit in the apertures 460 and 470 on the upper face 480 of the elongated body member 400; and
the bars 562 and 564 on the lower face 520 of the inlay member 500 fit into the apertures 482 and 484 of the elongated body member 400.

The insertion member 600 is made to fit snugly inside the elongated body member 400. The grooves 620 of the insertion member are spaces where the ribs 442 of the elongated body member 400 fit and hold the insertion member 600 inside the elongated body member 400.

The bolster 700 fits onto and over the ridge 472 or raised portion on the upper face 480 of the elongated body member 400. The depression 740 inside the bolster 700 fits over the ridge 472 to hold the bolster 700 in place.

The present handle 200 can be formed by molding the elongated body member, overmolding at least a portion of the elongated body member, molding the inlay member, plating at least a portion of the inlay member, molding the insertion member, molding the bolster, plating at least a portion of the bolster, and assembling the handle from the components molded. In a preferred embodiment, the elongated body member comprises polypropylene overmolded with santoprene, the inlay member comprises acrylonitrile butadiene styrene with chrome plating, the insertion member comprises acrylonitrile butadiene styrene, and the bolster comprises acrylonitrile butadiene styrene with chrome plating.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A handle for a kitchen tool comprising:
an elongated body member having an upper and lower face, lateral walls, a receiving end, and a hanging end, and having an inlay member receiving assembly, an insertion member receiving assembly, and a bolster receiving assembly;
an inlay member located on the upper face of the elongated body member by the inlay member receiving assembly;
an insertion member fittable into the receiving end of the elongated body member by the insertion member receiving assembly; and
a bolster fittable over the insertion member and the receiving end of the elongated body member by the bolster receiving assembly.

2. The handle of claim 1 further comprising polypropylene overmolded with a soft wrapping of santoprene on the lower face and lateral walls.

3. The handle of claim 1, wherein the inlay member receiving assembly comprises one or more apertures sized and spaced to interact with cooperative extensions of the inlay member, wherein the inlay member is pressed fittable to the elongated body member.

4. The handle of claim 1, wherein the insertion member receiving assembly comprises one or more ribs extending within a hollow space from an interior lateral wall of the receiving end of the elongated body member to interact with cooperative extensions of the insertion member when the insertion member is inserted into the receiving end of the elongated body member.

5. The handle of claim 1, wherein the bolster receiving assembly comprises one or more depression inside the bolster member to interact with cooperative extensions of the elongated body member when the bolster member is placed over the receiving end of the elongated body member.

6. The handle of claim 1 further comprising injection molded acrylonitrile butadiene styrene plated with chrome on the upper face of the elongated body member.

7. The handle of claim 1, wherein the insertion member comprises a tool aperture.

8. The handle of claim 1, wherein the bolster comprises a tool aperture.

9. The handle of claim 1, wherein the elongated body member comprises polypropylene overmolded with santoprene, the inlay member comprises acrylonitrile butadiene styrene with chrome plating, the insertion member comprises acrylonitrile butadiene styrene, and the bolster comprises acrylonitrile butadiene styrene with chrome plating.

10. A handle for a kitchen tool comprising:
an elongated body member having an upper and lower face, lateral walls, a receiving end, and a hanging end, and having an inlay member receiving assembly, an insertion member receiving assembly, and a bolster receiving assembly;
an inlay member located on the upper face of the elongated body member by the inlay member receiving assembly;
an insertion member fittable into the receiving end of the elongated body member by the insertion member receiving assembly; and
a bolster fittable over the insertion member and the receiving end of the elongated body member by the bolster receiving assembly;
wherein the inlay member receiving assembly comprises one or more apertures sized and spaced to interact with one or more cooperative extensions of the inlay member, wherein the inlay member is pressed fittable to the elongated body member;
wherein the insertion member receiving assembly comprises one or more ribs extending within a hollow space from an interior lateral wall of the receiving end of the elongated body member to interact with one or more cooperative extensions of the insertion member when the insertion member is inserted into the receiving end of the elongated body member; and
wherein the bolster receiving assembly comprises one or more depression inside the bolster member to interact with one or more cooperative extensions of the elongated body member when the bolster member is placed over the receiving end of the elongated body member.

11. The handle of claim 10, wherein the insertion member and the bolster comprise a tool aperture.

12. The handle of claim 10, wherein the inlay member receiving assembly comprises a first set of three circular apertures, and a second set of two rectangular apertures, wherein a coupling link of the inlay member fits into one of the three circular apertures of the elongated body member, wherein two pins extending from the inlay member fit within the other two of the three circular apertures of the elongated body member, and wherein two bars of the inlay member fit within the second set of two rectangular apertures of the elongated body member.

13. The handle of claim 12, wherein the elongated body member comprises polypropylene overmolded with santoprene, the inlay member comprises acrylonitrile butadiene styrene with chrome plating, the insertion member comprises acrylonitrile butadiene styrene, and the bolster comprises acrylonitrile butadiene styrene with chrome plating.
